(19) United States
(12) Patent Application Publication
(10) Pub. No.: US 2002/0169963 A1
(43) Pub. Date: Nov. 14, 2002

(54) Digital watermarking apparatus, systems and methods

(76) Inventors: Phillip Andrew Seder, Portland, OR (US); William Ray Cooley, Tulsa, OK (US); Thomas J. Huguenard, Claremore, OK (US)

Correspondence Address: DIGIMARC CORPORATION, 19801 SW 72ND AVENUE, SUITE 100, TUALATIN, OR, 97062, US

(21) Appl. No.: 09/864,084

(22) Filed: May 22, 2001

Related U.S. Application Data
(63) Continuation-in-part of application No. 09/853,835, filed on May 10, 2001.

(51) Int. Cl. H04L 9/00

(52) U.S. Cl. 713/176; 380/44

(57) ABSTRACT

A variety of systems responsive to watermarked documents are detailed. In one, a system includes a user terminal, a central site, and a website. The user terminal includes a watermark reader, and a capture device to capture an image of a watermarked document. The central site includes a database of watermark identifiers. The user terminal communicates an extracted watermark identifier to the central site. The central site interrogates a database via the extracted watermark identifier to find any related information. The central site generates a validation key and communicates such to the user terminal. The validation key can be used by the website to validate access by the user terminal.

### RELATED APPLICATION DATA

This application is a continuation-in-part of U.S. application Ser. No. 09/853,835, entitled “Digital Watermarking Apparatus, Systems and Methods,” filed May 10, 2001. This application is related to U.S. patent application Ser. Nos. 09/562,049, filed May 1, 2000, and 09/790,322, filed Feb. 21, 2001. This application is also related to PCT Application No. PCT/US 01/14014, filed in the United States Receiving Office on Apr. 30, 2001, entitled “Digital Watermarking Systems.”

### FIELD OF THE INVENTION

The present invention relates to digital watermarking systems and methods, and is particularly illustrated with reference to a verification system and method.

### BACKGROUND AND SUMMARY OF THE INVENTION

Digital watermarking technology, a form of steganography, encompasses a great variety of techniques by which plural bits of digital data are hidden in some other object without leaving human-apparent evidence of alteration.

Digital watermarking may be used to modify media content to embed a machine-readable code into the data content. The data may be modified such that the embedded code is imperceptible or nearly imperceptible to the user, yet may be detected through an automated detection process.

Most commonly, digital watermarking is applied to media such as images, audio signals, and video signals. However, it may also be applied to other types of data, including documents (e.g., through line, word or character shifting, through texturing, graphics, or backgrounds, etc.), software, multi-dimensional graphics models, and surface textures of objects.

Digital watermarking techniques can also be applied to traditional physical objects, including blank paper. Such blank media, however, presents certain challenges since there is no image that can serve as the carrier for the watermark signal.

The surface of a blank paper or other document (or physical object) can be textured with a pattern of micro-indentations to steganographically encode plural-bit information. The texturing is optically discernible, e.g., by a scanner, permitting the digital data to be decoded from scan data corresponding to the paper object.

There are other processes by which media can be processed to encode a digital watermark. Some techniques employ very subtle printing, e.g., of fine lines or dots, which has the effect slightly tinting the media (e.g., a white media can be given a lightish-green cast). To the human observer the tinting appears uniform. Computer analyses of scan data from the media, however, reveals slight localized changes, permitting a multi-bit watermark payload to be discerned. Such printing can be by ink jet, dry offset, wet offset, xerography, etc.

Other techniques extend the texturing techniques, e.g., by employing an intaglio press to texture the media as part of the printing process (either without ink, or with clear ink).

The encoding of a document can encompass artwork or printing on the document, the document's background, a laminate layer applied to the document, surface texture, etc. If a photograph or image is present, it too can be encoded.

Printable media—especially for security documents (e.g., banknotes) and identity documents (e.g., passports)—is increasingly fashioned from synthetic materials. Polymeric films, such as are available from UCB Films, PLC of Belgium, are one example. Such films may be clear and require opacification prior to use as substrates for security documents. The opacification can be affected by applying plural layers of ink or other material, e.g., by gravure or offet printing processes. (Suitable inks are available, e.g., from Sicpa Securink Corp. of Springfield, Va.) In addition to obscuring the transparency of the film, the inks applied through the printing process form a layer that is well suited to fine-line printing by traditional intaglio methods. Such an arrangement is more particularly detailed in laid-open PCT publication WO 98/33758.

Digital watermarking systems typically have two primary components: an embedding component that embeds the watermark in the media content, and a reading component that detects and reads the embedded watermark. The embedding component embeds a watermark pattern by altering data samples of the media content. The reading component analyzes content to detect whether a watermark pattern is present. In applications where the watermark encodes information, the reading component extracts this information from the detected watermark. Commonly assigned U.S. application Ser. No. 09/503,881, filed Feb. 14, 2000, discloses various encoding and decoding techniques. U.S. Pat. No. 5,862,260 discloses still others. Of course, artisans know many other watermark techniques that may be suitably interchanged with the present invention.

Embedded machine-readable code can be used to link to or otherwise identify related information. In one illustrative example, a document is embedded with an identifier (or machine readable code). The identifier is extracted by a watermark-reading device and is passed to a central server. The central server includes (or communicates with) a database with related information. The related information is indexed via watermark identifiers. Such related information may include a URL, web address, IP address, and/or other information. The extracted identifier is used to interrogate the central server database to locate corresponding related information, such as a URL. The URL is passed from the central server to the reading device, which directs a web browser with the URL. Commonly assigned U.S. application Ser. No. 09/571,422, filed May 15, 2000, discloses applications and examples of such techniques.

An enhancement can be made to the above systems and methods. Consider an example where a URL points to confidential material, or to a privileged website (e.g., a website accessible through watermarked documents, secret, etc.). In this case, it is advantageous to restrict access to the corresponding website, allowing access to only those users having physical possession of a corresponding watermarked document. Accordingly, there is a need for a verification system for use with watermark-based (or identifier-based) routing to websites, files, databases, networks, computers, etc.

The foregoing and other features and advantages of the present invention will be more readily apparent from the following detailed description, which proceeds with reference to the accompanying drawings.

### BRIEF DESCRIPTION OF THE DRAWINGS

FIG. 1 shows a system according to an illustrative embodiment of the present invention.

FIG. 2 illustrates an alternate communications path for the FIG. 1 system.

FIGS. 3-6 are flow diagrams illustrating various methods and system operations according to the present invention.

FIG. 7 illustrates a system according to an illustrative embodiment of the present invention.

FIGS. 8-12 are flow diagrams illustrating various methods and system operations according to the present invention.

### DETAILED DESCRIPTION

System Overview

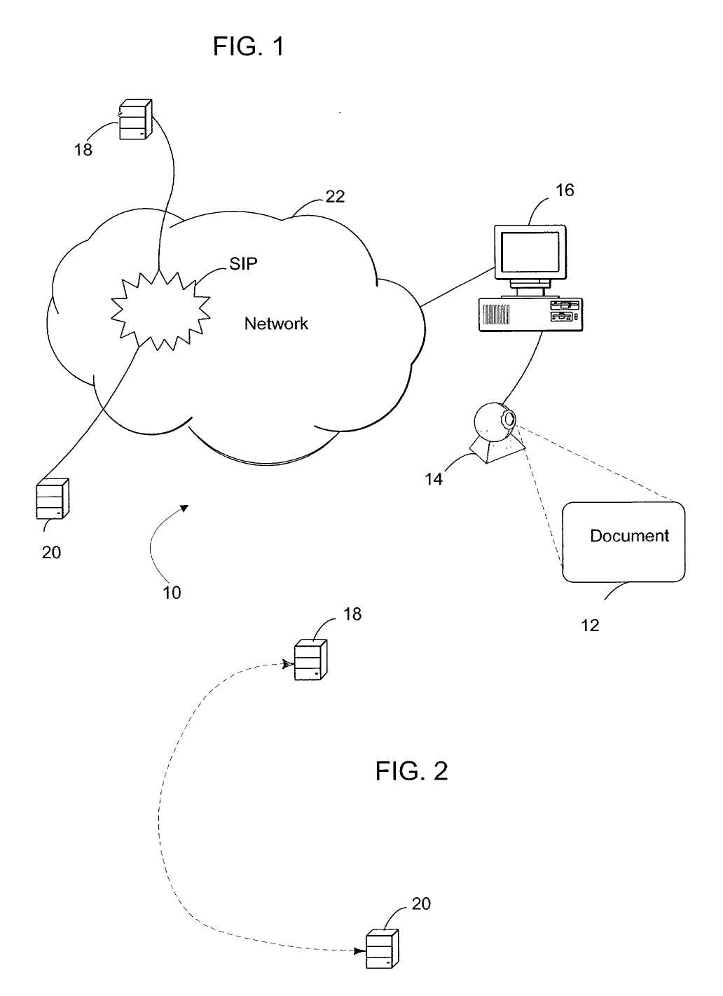

With reference to FIG. 1, a document 12 includes plural-bit digital data steganographically encoded therein (e.g., by digital watermarking). The document 12 can be an identification card (e.g., a driver's license, student ID, photo ID, identification document, or passport, etc.), a value document (e.g., a banknote, stock certificate, or other financial instrument), a trading card (e.g., baseball card, sports card, game card, character card, etc.), a magazine/newspaper image or article, advertisement, promotional, flier, stationary, envelope, letterhead, product package or label, candy wrapper, a credit card, a product manual, business card, bank or credit account card, printed document, picture, image, graphic, illustration, registration card, or virtually any other type of document. (In some embodiments, document 12 is a physical object such as a coffee cup, napkin, menu, soda pop can, jewelry, hardware, souvenir, etc.).

The encoding of the document 12 can encompass artwork or printing on the document 12, the document's background, a laminate layer applied to the document, surface texture, etc. If a photograph, graphic or image is present, it too can be encoded. A variety of watermark encoding techniques are detailed in the cited patent documents; artisans in the field know many more.

In an illustrative embodiment, document 12 is encoded with a payload, e.g., 2-256 bits. This payload is preferably processed before encoding, using known techniques (e.g., convolutional coding, turbo codes, etc.), to improve its reliable detection in adverse conditions. The payload preferably includes a document identifier. The document identifier may uniquely identify the document, or may identify a set of documents, or a subset of documents.

The encoded document 12 is presented to an input device 14 for image capture. The input device 14 can take various forms, including a flatbed scanner, a hand scanner (including an imaging mouse), a video camera, a digital camera, a web cam, a digital eye, optical sensor, image sensor, a CMOS or CCD sensor, etc. The input device 14 is in communication with terminal 16. Of course, instead of being tethered to terminal 16, as shown in FIG. 1, input device 14 may be in wireless communication (e.g., IF, RF, etc.) with terminal 16, or may be integral with respect to terminal 16.

Terminal 16 preferably includes a general purpose or dedicated computer, incorporating electronic processing circuitry (e.g., a processor), memory (e.g., RAM, ROM, magnetic and/or optical memory, etc.), an interface to the input device 14, a display screen or other output device, and a network connection. The network connection can be used to connect to a network 22, such as an intranet, internet, LAN, WAN, wireless network, or other such network, to communicate with at least computers 18 and 20. (Of course, terminal 16 may be a handheld computing device, instead of the computing terminal shown in FIG. 1, such as is disclosed in assignee's U.S. patent application Ser. No. 09/842,282, filed Apr. 24, 2001.).

Suitable software programming instructions, stored in terminal 16's memory, can be used to affect various types of functionality for terminal 16. One such functionality is web browsing (or other communication); another is digital watermark reading.

Returning to FIG. 1, terminal 16 may occasionally communicate with servers (or computers) 18 and 20 (e.g., via a web browser or other communication interface). Computers 18 and 20 maintain and execute software, e.g., for hosting (and/or supporting) web pages, communication, and/or database management, etc. Computers 18 and 20 also maintain suitable software program instructions to help facilitate the system operations described herein. Of course, system 10 may optionally include additional computer servers.

Computer 18 can be referred to as a central server, since it preferably includes a repository or database of unique identifiers. In one embodiment, central server 18 includes a plurality of servers, or a plurality of distributed servers. The identifiers are associated in the unique identifier database (or data record, table, etc.) with related information, such as URLs, IP addresses, data files, multimedia files, HTML code, XML code, and/or Java applets, etc. The database may be directly associated with server 18, or may be remotely accessed.

Server 20 preferably supports a website or other interface for internet (or other network) access.

Servers 18 and 20 preferably communicate via a secure, session-oriented internet protocol (“SIP”) connection. This type of connection helps to prevent unauthorized eavesdropping by a third party. In an alternative embodiment, servers 18 and 20 communicate in a non-SIP fashion. In a further embodiment, as shown in FIG. 2, servers 18 and 20 have a dedicated communication path through which communication is carried out.

System Operation

An example is provided as an initial overview of one aspect of the system 10 operation. A more detailed discussion of additional aspects follows. Consider the following example.

A website owner wishes to restrict access to her website. The owner would like to restrict access to only those users who have physical possession of a linking digitally watermarked document. (In this example, a linking watermarked document is one that is used to link, either directly or indirectly, to a website.). A computer and input device scans (or image captures) the digitally watermarked document. A watermark decoder extracts an embedded identifier from the scanned document. The watermark identifier is provided through a network to a central server. The central server identifies a URL associated with the watermark identifier and creates a verification record. The verification record includes a verification key and the identifier. The verification key is provided, along with the URL, to the computer. The computer initiates communication with a website corresponding to the URL, and provides the verification key to the website. The website communicates the verification key and a list of valid watermark identifiers to the central server. The central server then compares the verification key and list of watermark identifiers against the corresponding verification record. If they match, the central server signals the website to allow the computer to access the website. Thus, physical possession of a watermarked document is ensured and/or a user is authorized to access a website.

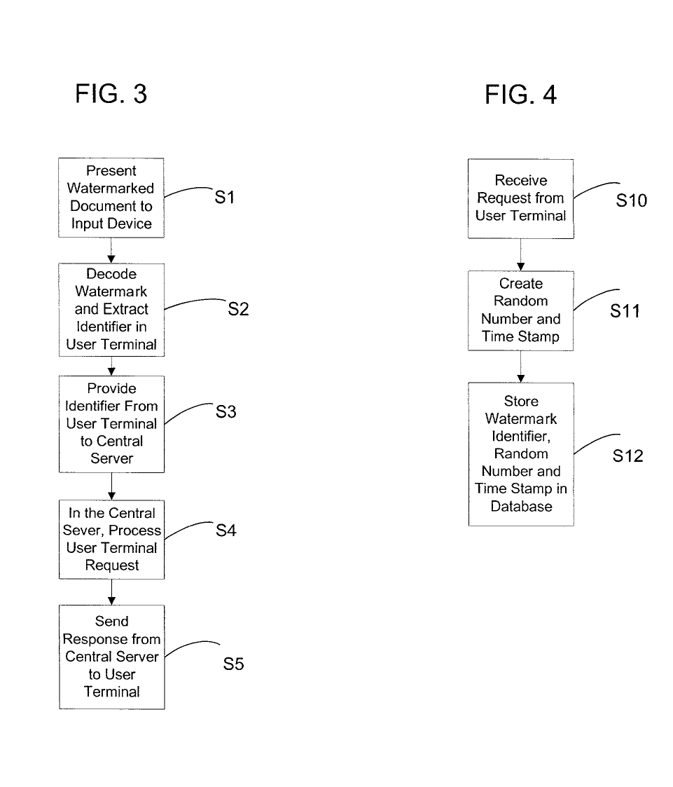

Further aspects of the present invention are now disclosed. With reference to FIGS. 1 and 3, a digitally watermarked document 12 is presented to input device 14 (step S1, FIG. 3). The input device 14 captures an image(s) of the document and conveys such to terminal 16. Executing watermark decoding software instructions (e.g., a “decoder”), terminal 16 decodes the digital watermark embedded within the captured image data and recovers the watermark identifier (step S2). Of course, the decoder may be integrated into various software applications, operating system, web browser, independent software module, device, system, etc. Such a decoder detects and reads an embedded watermark (or watermarks) from a signal suspected of containing the watermark. In one embodiment, the decoder includes Digimarc MediaBridge software, available at www.digimarc.com or through Digimarc Corporation, headquartered in Tualatin, Oreg., U.S.A. Of course, other watermark decoding software may be used in other embodiments.

The extracted watermark identifier (“ID”) is provided from terminal 16 to server 18 (step S3). In one embodiment, the decoder facilitates such communication. In another embodiment, the decoder provides the extracted ID to another software application (communication package, web browser, etc.), which provides the ID to server 18.

At server 18, the ID is processed (step S4). Preferably, such processing includes a step of uniquely identifying a request. Here, a request includes the extracted watermark ID sent to server 18 from terminal 16. FIG. 4 illustrates one such processing method. A request is received in step S10. The request is uniquely identified by generating a random number (step S11). The random number is associated with a corresponding watermark ID and a date/time stamp (step S12). The random number, watermark ID and date/time stamp (referred to generally as a “time stamp”) can be maintained in a database, table, data record and/or in another data structure. Such a table (or database, data record, etc.) is referred to herein generally as a response information table. The time stamp can identify the time of receipt, and/or the processing or response time of the watermark ID. Preferably, the random number is large enough to uniquely identify the request, e.g., 4-256 bits.

Upon receipt of a request, server 18 preferably interrogates its information database to identify any related information, such as a URL or IP address, which is associated with the ID.

Server 18 communicates a response to terminal 16 (step S5, FIG. 3). Typically, a response includes a URL (or IP address). Preferably, the response also includes response information, such as the generated random number and the time stamp.

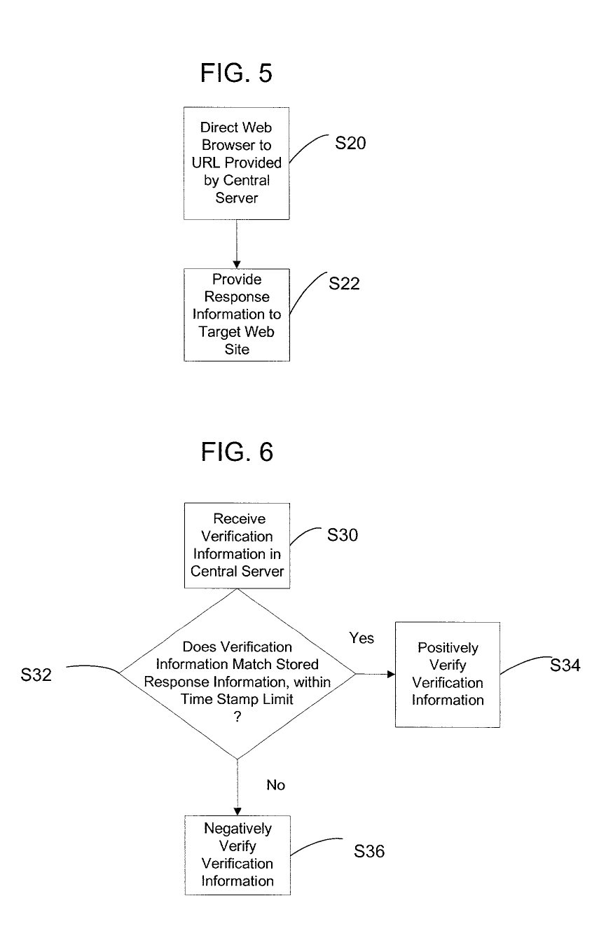

With reference to FIG. 5, upon receipt of the response, terminal 16's web browser is directed by the URL (or other pointer) provided in the server 18 response (step S20). In one embodiment, the decoder controls (e.g., calls or opens) the web browser and provides the web browser with the URL. In this example, the URL points to server 20's website. In another embodiment, the decoder and web browser are integrated, or the decoder is a web browser plug-in. In still another embodiment, the URL is communicated directly to the web-browser. The response information, or a subset of the response information, is provided from terminal 16 to the target website, e.g., server 20 (step S22). For example, terminal 16 provides the random number and the time stamp to server 20.

With reference to FIG. 1, server 20 communicates with server 18, preferably via a secure, session-oriented internet protocol (“SIP”) connection 24. Server 20 communicates verification information via the SIP connection 24. Such verification information preferably includes the random number, the time stamp and a list of watermark IDs that are valid for the sever 20 website. The list of watermark IDs may include one or more watermark IDs. A valid ID is an ID that is allowed to access the website. (In another embodiment, a valid ID is one that is prohibited from accessing the website.).

With reference to FIG. 6, server 18 receives the verification information in step S30. In step S32, server 18 determines whether the verification information (e.g., the random number and the time stamp) matches any of the entries stored in the response information table (or database, data record, etc.) within a predetermined time period. The random number can be used to index into the response information table. (Alternatively, the list of watermarks IDs is used to interrogate the table to locate associated time stamps and random numbers.). Preferably, the predetermined time period is the most recent 0-15 minutes. More preferably, the predetermined time period is the last 0-60 seconds. A typical response time may be in the range of 45-60 seconds.

If a match is found, a positive response is provided to server 20 (via a website maintained by server 20), e.g., as shown in step S34. Terminal 16 is allowed access to the server 20 website upon receipt of a positive response. If no match is found, a negative response is provided to server 20, e.g., as shown in step S36, and terminal 16 is prohibited from accessing the website.

In another embodiment, upon receipt of a positive verification, server 20 (via the website maintained by server 20) prompts terminal 16 for a PIN or password. Only after a correct PIN or password is received is the user allowed access to the website.

Adding a random number (and optionally, a time stamp) provides enhanced security for linking to websites via a watermark ID. In one case, the random number assists in deterring would-be hackers from making redirection requests, since they must uses a random number matching scheme.

For even further security, a random number can be encrypted. In one embodiment, the user terminal 16, and then server 20, merely passes the encrypted random number back to the server 18, where it is decrypted for verification. In another embodiment, encryption of the random number occurs at terminal 16 using a shared secret stored in the watermark decoder. Terminal 16 is directed to computer 20, and provides server 20 with the encrypted random number. Server 20 passes the encrypted random number to server 18. Server 18 then decrypts the random number using the same-shared secret. This embodiment helps to prevent those who gain knowledge of the watermark ID associated with a particular image from using an application other than an authorized watermark decoder to access the secure web page. Public/Private key encryption is used for even more secure implementations in other embodiments.

A time stamp can also be encrypted. Increased security is even further enhanced by randomly assigning watermark identifiers for related documents. Consider the following example. A series of baseball cards (e.g., 100 cards) are embedded with unique watermark identifiers. Each of the unique identifiers is randomly generated, instead of sequentially identifying the cards. This may help to prevent unauthorized access or copy based attacks on the series of cards, once an identifier or URL is discovered for one or more cards.

Alternative System Operations

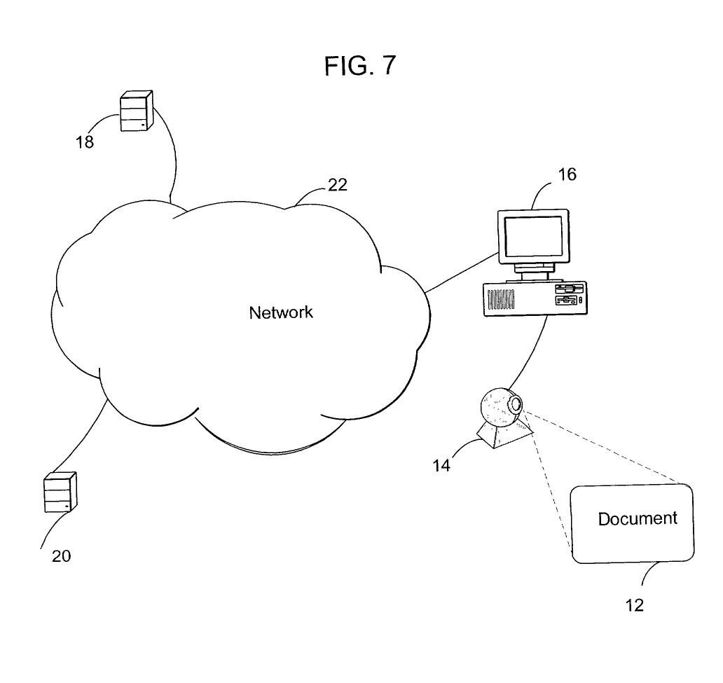

A further embodiment will be discussed with respect to FIG. 7, in which like components are referenced with the same reference numbers. User terminal 16 receives a captured image of digitally watermarked document 12, via input device 14. User terminal 16 executes watermark-decoding software (a “decoder”) to extract a digitally watermarked message (e.g., an identifier or payload) from the captured image. The message is relayed to server 18 through network 22. Of course, the decoder may be integrated into various software applications, operating system, web browser, independent software module, device, system, etc. In one embodiment, the decoder includes Digimarc MediaBridge software, available at www.digimarc.com or through Digimarc Corporation, headquartered in Tualatin, Oreg., U.S.A. Of course, other watermark decoding software may be used in other embodiments.

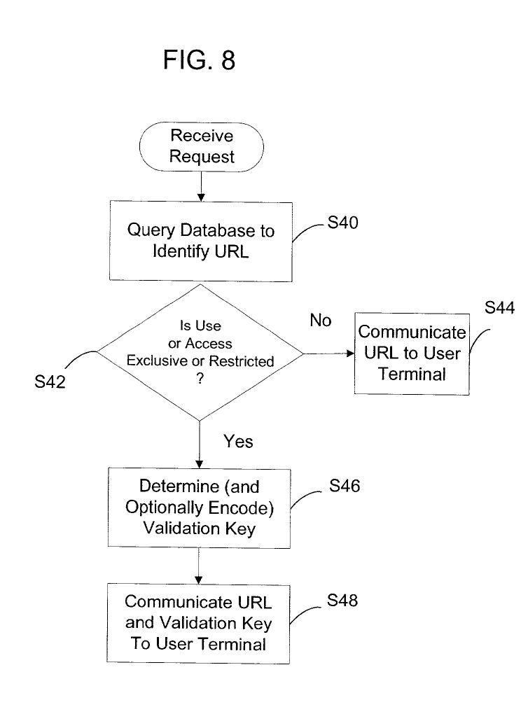

Upon receipt of the message (sometimes referred to as a “request”), server 18 queries an associated database to retrieve a corresponding pointer, e.g., a URL or IP address (step S40, FIG. 8). In step S42, it is determined whether the URL is associated with a restricted-access or exclusive website. If access is not restricted, the URL is communicated to the user terminal 16 in step S44. If access is restricted, a validation key is determined (and optionally encoded) in step S46. The URL and validation key are communicated to the user terminal in step S48.

Restricted access or exclusivity can be identified in a number of ways. One way is to set a flag or store another parameter with the URL to indicate such status. The server (or software running on such) then checks the flag or parameter to determine exclusivity. Another way is to store exclusive or restricted URLs in a list, database, table, etc. When a URL is selected in response to a message, the server 18 (or software running on such) then determines whether the selected URL is listed in the list, database or table. If the URL is listed it is determined to be exclusive or restricted.

A validation key can include a variety of information. In one embodiment, the validation key is a predetermined number, or a pseudo-random number. In another embodiment, the validation key is a date-time stamp, which can be encoded prior to communication to the user terminal 16. (Server 20 can include an internal clock, which is consulted to generate the timestamp. Alternatively, server 20 can communicate with an external computer (or clock) to obtain a timestamp (or information to generate a timestamp). As a further alternative, server 20 can include processes to estimate a time, and such an estimate can be used to generate a timestamp.). The term “encoding” as used herein may include various functions or a combination of functions. One such function is a so-called hashing algorithm, which mathematically (or systematically) converts the validation key into a value, code or to a lower number of bits. Examples of hashing algorithms include MD5, MD2, SHA, and SHA1, among others. Of course there are other hashing algorithms known to those skilled in the art, and such may be suitably employed with the present invention. Another encoding function is encryption. In this case, the date-time value is encrypted using a key (e.g., a public/private or symmetrical key). Still other encoding functions are rotation processes, which predictably alter a validation key. Consider the following example.

In one rotation process, sever 18 preferably maintains a list (or database structure) including valid key codes. The key codes are transmitted as part of a validation key value. A key code is used both for encoding and decoding. Accordingly, the key codes are preferably shared with a client site, such as server 20. Now consider a timestamp as the validation key, which has the following format: YYMMDDHHMMSSmmm, where YYMMDD is the date (in years, months and days), HHMMSS is the time (in hours, minutes, and seconds), and mmm is the number of milliseconds into a current second. The timestamp (e.g., YYMMDDHHNNSSmmm) is converted to an alpha-equivalent by, e.g., substituting “A” for “0,” “B” for “1,” etc. For instance, a timestamp of 0105181700123 would become ABAFBIBHAABCD. (In another embodiment, “Y” for 0, “Z” for 1, “A” for 2, and so on. In still another embodiment, the time code is converted to an alpha-numeric code. In yet another embodiment, the timestamp is coding using other matching schemes.). Once determined, a key code can be expanded to enough characters to fit the time-stamp input string by concatenating multiple copies. For instance, a key code of “12321” might be expanded to be “123211232112321” (or “123210000012321,” “123211111111111,” “000001232111111,” etc.). The expanded key code and the timestamp are then combined. For example, the two strings could be added, subtracted, multiplied together, etc., to achieve a new string. Optionally, the corresponding key code is then concatenated (or encoded) in the new string. For example, a key code of “EDCB” could be added to the beginning, end, or an internal portion of the new string. More preferably, the key code is broken up and distributed (or encoded) throughout the new string. For example, the first character “E” is placed in the third position of the string and the 4^{th}-N string characters are shifted (where N is the total number of string characters), the next character “D” is placed in the twelfth position and the characters are shifted, the third character “C” is placed in the seventh position, or so on. The resulting string becomes a validation key.

In a related embodiment, the encoding key code is not transmitted in the validation string. A corresponding client already knows (or separately obtains) the key code, and decodes accordingly.

In a further related embodiment, a timestamp (or predetermined number) is encrypted, and the encrypted timestamp is used as the validation key.

In yet another related embodiment, a key code is not expanded (or is only partially expanded), and is added to a subset of the timestamp.

A resulting validation key is preferably appended to a URL for communication to user terminal 16. In the preferred embodiment, the URL points to server 20, which supports a website. The website can be created using, in part, HTML code and/or ASP files (i.e., Active Server Pages). One possible format for the appended validation string is:

<http://www.digimarc.com?ID=123432&Page=annual.asp&DigiExclusive=aldsfuewfsdf asdf>,

where “DigiExclusive” is the validation key parameter name, and “aldsfuewfsdfasdf” is a corresponding validation key value. In this example, the corresponding value is an encoded validation key.

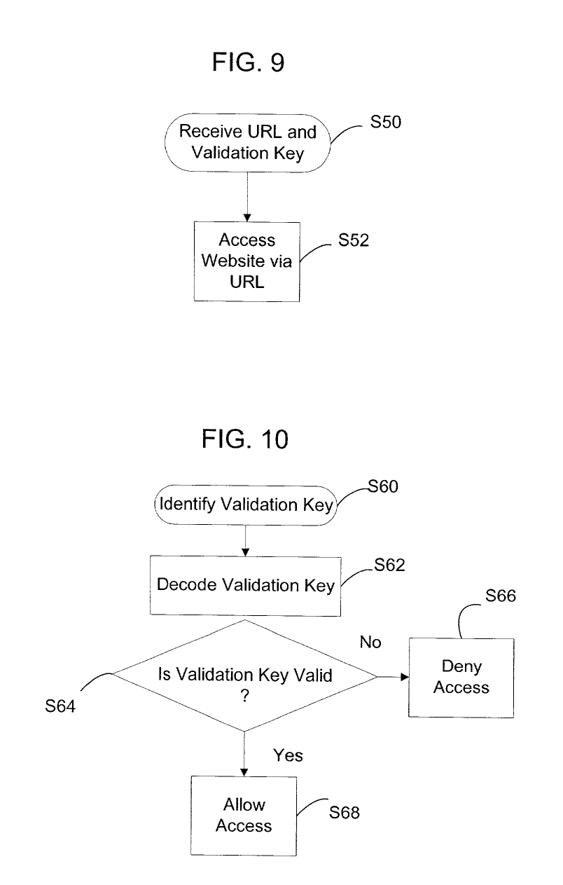

With reference to FIG. 9, user terminal receives the URL and validation key from server 18 (step S50). Terminal 16's web browser is directed by the URL (or other pointer) provided in the server 18 response (step S52). In one embodiment, the decoder controls (e.g., calls or opens) the web browser and provides the web browser with the URL. In this example, the URL points to server 20's website. In another embodiment, the decoder and web browser are integrated, or the decoder is a web browser plug-in. In still another embodiment, the URL is communicated directly to the web-browser.

Upon receipt of an appended URL, and prior to allowing access to the website by user terminal 16, server 20 identifies the validation key, if any (step S60, FIG. 10). In a first embodiment, user terminal 16 communicates the validation key to the server 18, which identifies the validation key as such. As will be appreciated, there are others ways to identify a validation key. In another example, server 20 queries an appended URL string for a particular parameter name (e.g., “DigiExclusive”), and then determines an associated value (e.g., “aldsfuewfsdfasdf”), which value includes the validation key. ASP files can be interpreted by web server software in such a way as to permit the inclusion of an “Active Scripting Language,” such as VB Script, among others. Such a script has access to objects, which describe and control the interpretation of the ASP file. One such object is a “Request” object, which among other things describes an incoming request. The Request object can provide a process or method called “QueryString,” which, when queried for a Key Name (e.g., “DigiExclusive”) returns the value for that key (e.g., “aldsfuewfsdfasdf”) as found in the URL.

A validation key (e.g., a key value) is decoded once it is identified (step S62). As discussed, server 20 preferably has a corresponding decoding key. Alternatively, the decoding key is included in the validation key itself. If the validation key is encrypted, server 20 preferably includes (or obtains) the necessary key to decrypt the validation key. In step S64, sever 20 determines whether the validation key is valid. In the preferred embodiment, the validation key includes a timestamp. Once decoded, server 20 determines whether the timestamp is within an acceptable time range. For example, server 20 may determine whether the timestamp is stale. A stale timestamp may be one that falls outside of a predetermined period (e.g., the last 15 minutes, 1-5 hours, week, etc.). If the timestamp is stale (e.g., the validation key is invalid), user terminal 16 is denied access to the website (step S66). If the timestamp is not stale (e.g., the validation key is valid), the user is allowed access to the website (step S68).

In another embodiment, instead of a timestamp, a predetermined number (or other value) is the validation key. Server 20 then compares the predetermined number (or value) with a list of valid numbers. Access is permitted if a match is found, indicating the validation key is valid.

Such a validation process helps to prevent (or limit) unauthorized access, particularly from book marking or copied URLs. Accordingly, access to an exclusive website is restricted by requiring a watermark-based access.

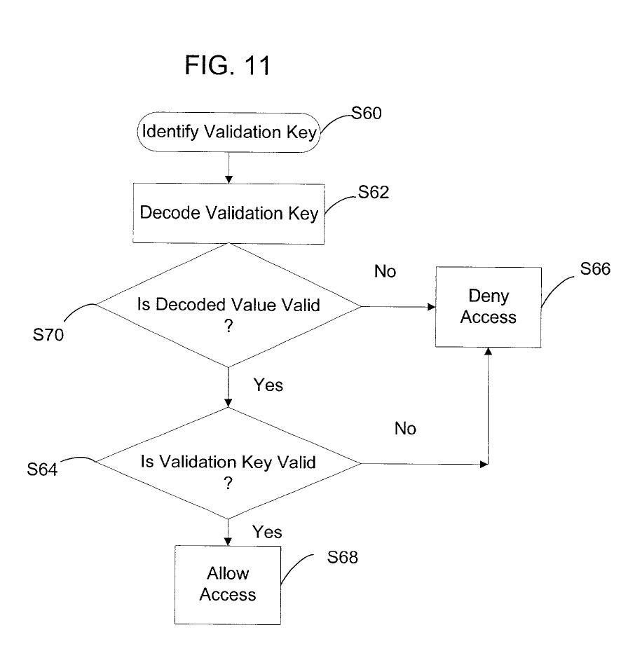

FIG. 11 illustrates a process that is related to the FIG. 10 embodiment, in which like steps are illustrated with like numbers. In the FIG. 11 embodiment, after a validation key is decoded (step S62), server 20 determines whether the resulting decoded validation key has a proper format and/or includes proper characteristics (step S70). For example, sever 20 determines whether the decoded key has a proper amount of characters, is the right size, falls within a predetermined range, etc. Alternatively, in the event that the validation key corresponds with a timestamp, the decoded timestamp is provided to a format checker (e.g., a visual basic routine expecting to receive a date-time format, a process or software routine to determine valid time formats, etc.). The format checker signals whether the timestamp has a valid form. If the decoded value is not valid, access to the website is denied (step S66). Otherwise flow continues to step S64 as discussed above with respect to FIG. 10.

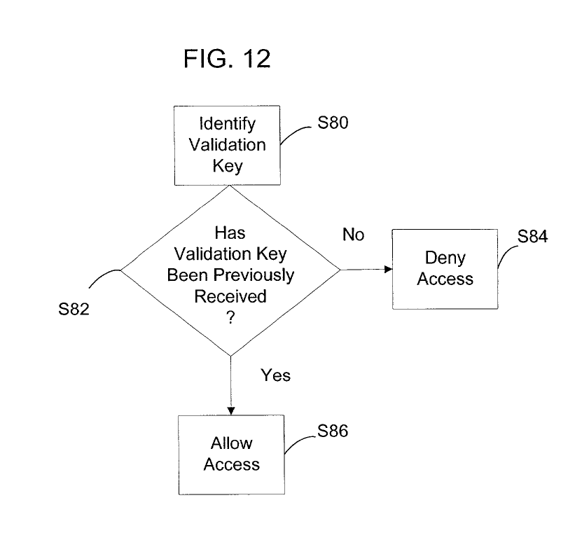

An optional validation feature is now explained with reference to FIG. 12. Upon receipt of an appended URL, server 20 identifies a validation key as discussed above. Each received validation key is stored in a database, list, table, etc. (Of course, such a database can be refreshed, e.g., by limiting the lifespan of stored entries, or by periodically clearing the database.). For example, the methods illustrated in FIGS. 10 and 11 could optionally include a step of storing the validation key in the database, for valid keys.

Returning to FIG. 12, server 20 identifies a validation key (step S80). In step 82, server 20 queries the validation key database to determine whether the validation key has been previously received (or received within a predetermined time period). If the validation key is stored in the database (or has been received within a predetermined period), access to the website is denied (step S84). Otherwise access to the website is allowed (S86). Of course the validation checking method illustrated in FIG. 12 could be combined with the methods illustrated in FIGS. 10 and/or 11. Such a system helps to prevent copy attacks again the system.

Such systems and methods help to regulate access to websites, particularly websites accessible through linked identifiers (e.g., digital watermark identifiers).

Concluding Remarks

The foregoing are just exemplary implementations of an online verification system. It will be recognized that there are a great number of variations on these basic themes. The foregoing illustrates but a few applications of the detailed technology. There are many others.

Consider, for example, the use of embedded watermark data in a document to allow access to a resource. A document may be used to grant physical access through a normally locked door. Or a document may be used to logon to a computer network—with directory privileges tied to the data linked to the document.

In some cases, the data encoded in the document fully replicates certain information associated with the document (e.g., the bearer's last name or initials, or OCR printing, or mag-stripe data, etc.). Or the encoded data can be related to other information on the document in a known way (e.g., by a hash function based on the bearer's printed name, or the full-text card contents). Or the encoded data can be unrelated to other information on the card.

In many embodiments, the data encoded in the document may serve as an index to a larger repository of associated data stored in a remote database, e.g., on computer 18. Thus, for example, an index datum read from a passport may allow a passport inspector to access a database record corresponding to the encoded data. This record may include a reference photograph of the passport holder, and other personal and issuance data. If the data obtained from the database does not match the text or photograph included on the card, then the card has apparently been altered.

Instead of a central server generating a random number, a pseudo-random number, coded number, and/or a predetermined number could be generated instead, so long as a request is uniquely identified.

Having described and illustrated the principles of the invention with reference to illustrative embodiments, it should be recognized that the invention is not so limited. In fact, whereas the above embodiments have been described with respect to linking to a URL or website, the present invention is not so limited. The inventive concepts disclosed herein can be used to access a locked system, access a restricted file or network areas, or even enter a restricted area. In this case, a user terminal (or security lock) can communicate directly with a central computer, or via a network.

The section headings in this application (e.g., “System Operation”) are provided merely for the reader's convenience, and provide no substantive limitations. Of course, the disclosure under one section heading may be readily combined with the disclosure under another heading.

While the detailed embodiments employ digital watermark technology, other technologies can alternatively be employed. These include barcodes, data glyphs, RFID devices, magnetic stripes, organic transistors, smart cards, etc. Taking as a particular example the document presentment concept, much the same functionality can be obtained by providing, e.g., an RFID device in a document, and providing an RFID sensor at a user's computer (e.g., in a mouse pad).

To provide a comprehensive disclosure without unduly lengthening this specification, the above-mentioned patent and patent applications are hereby incorporated by reference. The particular combinations of elements and features in the above-detailed embodiments are exemplary only; the interchanging and substitution of these teachings with other teachings in this application and the incorporated-by-reference patent/applications are also contemplated.

The above-described methods and functionality can be facilitated with computer executable software stored on computer readable media, such as electronic memory circuits, RAM, ROM, magnetic media, optical media, removable media, etc. Such software may be stored on a user terminal, and/or distributed throughout a network. Data structures representing the various data structures (tables, data records, databases, etc.) may also be stored on such computer readable mediums. Also, instead of software, a hardware implementation can be used.

It should be appreciated that the timestamp format given above is provided by way of example only. Of course, other formats can be used with the present invention. For example, formats may exclude the year, milliseconds, and/or seconds. In another arrangement, only the month and day are used. In still another arrangement, only minutes and day are used. Other combinations are possible. Similarly, the concatenated URL and validation key given above is provided as an example. Other validation names and values can be used, as well as other target URLs and parameters.

In an alternative embodiment, with reference to FIG. 8, the central server 18 need not determine whether the use or access is exclusive (e.g., steps S42, S44). Instead, the server 18 moves from step S40 to step 46. In this case, all URL (or pointers) in the database are considered exclusive.

In view of the wide variety of embodiments to which the principles and features discussed above can be applied, it should be apparent that the detailed embodiments are illustrative only and should not be taken as limiting the scope of the invention. Rather, we claim as our invention all such modifications as may come within the scope and spirit of the following claims and equivalents thereof.

What is claimed is:

1. A method of regulating access to a website by a user terminal via the internet, the user terminal reading a document including an embedded digital watermark, said method comprising the steps of:
at the user terminal, extracting identifying data from the digital watermark, and providing the identifying data to a central computer;
at the central computer:
identifying a pointer associated with the identifying data;
generating a validation key; and
providing the pointer and the validation key to the user terminal;
at the user terminal, communicating with the website via the pointer and providing the validation key to the website; and
at the website, regulating access to the website by the user terminal based at least in part on the validation key.

2. The method according to claim 1, wherein the identifying data comprises a document identifier.

3. The method according to claim 2, wherein the pointer comprises at least one of a URL, IP address and web address.

4. The method according to claim 2, wherein the validation key comprises a date-time value.

5. The method according to claim 2, further comprising the step of encoding the validation key.

6. The method according to claim 5, wherein the encoding comprises at least one of hashing, encrypting, and rotating.

7. The method according to claim 5, wherein the encoding comprises converting a validation key to alpha-characters, and adjusting the characters according to a code key.

8. The method according to claim 7, further comprising the step of encoding the code key with the validation key.

9. The method according to claim 1, wherein the validation key comprises at least one of a predetermined number and a pseudo-random number.

10. A method of authenticating permission to access a system comprising the steps of:
receiving a request to enter the system, the request including at least a validation key;
determining whether the validation key is valid; and
allowing access to the system based on a determination of said determining step.

11. The method according to claim 10, wherein said system comprises a website.

12. The method according to claim 10, further comprising the step of decoding the validation key.

13. The method according to claim 10, wherein the validation key comprises a timestamp, and said determining step determines whether the timestamp is stale.

14. The method according to claim 10, wherein the validation key comprises a timestamp, and said determining step determines whether the timestamp is within a predetermined range.

15. The method according to claim 10, wherein the validation key comprises a predetermined number, and said determining step determines whether the predetermined number matches at least one number on a list of numbers.

16. The method according to claim 10, wherein the system provides information related to a digitally watermarked document.

17. The method according to claim 10, further comprising a step of determining whether the validation key comprises a valid value.

18. The method according to claim 17, wherein said validation key comprises a timestamp, and step of determining whether the validation key comprises a valid value includes determining whether the timestamp has a predetermined format.

19. The method according to claim 10, wherein the request includes a URL and the validation key is appended to the URL.

20. A method of authenticating permission to access a website via the internet, said method comprising the steps of:
receiving a request to enter the system, the request including at least a validation key,
determining whether the validation key has been previously received; and
allowing access to the system based on a determination of said determining step.

21. The method according to claim 20, wherein the validation key includes at least one of a date-time value, a pseudo-random number and a predetermined number.

22. The method according to claim 21, wherein said determining step comprises the steps of querying a database to determine if the validation key is stored therein.

23. A method according to claim 21, further wherein the request comprises a URL identified from a digitally watermark-based system.

24. A system for exchanging data comprising:
a central server comprising at least one database including pointer information, wherein when a user terminal communicates an extracted watermark identifier to said central server, said central server identifies a corresponding pointer associated with the extracted watermark identifier, and wherein said central server generates a validation key and encodes the validation key, and wherein said central server appends the validation key to the corresponding pointer, and communicates the pointer and validation key to the user terminal.

25. The system according to claim 24, wherein the pointer comprises at least one of a URL, IP address and web address.

26. The system according to claim 25, wherein the validation key comprises a date-time value.

27. The system according to claim 24, wherein said central server encodes by at least one of hashing, encrypting, and rotating.

28. The system according to claim 27, wherein the central server encodes by converting the validation key to alpha-characters, and adjusting the characters according to a code key.

29. The system according to claim 28, wherein the central server encodes the code key with the validation key.

30. The system according to claim 24, wherein the validation key comprises at least one of a predetermined number and a pseudo-random number.

31. A method of operating a computer server, the computer server to communicate with at least one user terminal, said method comprising the steps of:
receiving a document identifier from the user terminal;
identifying a pointer associated with the document identifier;
determining whether the pointer is a predetermined class, and
if not the predetermined class, communicating the pointer to the user terminal; and
if the predetermined class, generating a validation key, and communicating the pointer and validation key to the user terminal.

32. The method according to claim 31, wherein the pointer comprises at least one of a URL, IP address and web address.

33. The method according to claim 32, wherein the predetermined class comprises at least one of a restricted access website, exclusive access website, an entry-through-purchased documents website, a restricted URL, and an exclusive URL.

34. The method according to claim 33, wherein the validation key comprises at least one of a time stamp, a predetermined number, and a pseudo-random number.

35. The method according to claim 34, wherein said document identifier comprises an identifier extracted from a digitally watermarked document.

36. The method according to claim 35, further comprising the step of encoding the validation key.

37. The method according to claim 34, wherein said document identifier comprises an identifier extracted from a digitally watermarked document.

38. A computer server, said computer server to communicate with at least one user terminal, said computer server comprising:
means for receiving a document identifier from the user terminal;
means for identifying a pointer associated with the document identifier;
means for determining whether the pointer is a predetermined class, and
if not the predetermined class, means for communicating the pointer to the user terminal; and
if the predetermined class, means for generating a validation key, and communicating the pointer and validation key to the user terminal.
